(19) United States
(12) Patent Application Publication
(10) Pub. No.: US 2001/0055900 A1
(43) Pub. Date: Dec. 27, 2001

(54) Contact pin

(76) Inventor: Rikihito Yamasaka, Nirasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/873,203

(22) Filed: Jun. 5, 2001

(30) Foreign Application Priority Data
Jun. 15, 2000 (JP) 2000-180207

(51) Int. Cl. H01R 29/00

(52) U.S. Cl. 439/169

(57) ABSTRACT

A contact pin for use in a contactor for inspecting electrical characteristics of a to-be-inspected object, comprising a shank having a lower end surface directed to the to-be-inspected object, and a needle end section provided on a portion of the lower end surface. At least part of that portion of the lower end surface, on which the needle end section is not provided, serves as a reflection surface for enabling optical detection of the contact pin.

### CROSS-REFERENCE TO RELATED APPLICATIONS

This application is based upon and claims the benefit of priority from the prior Japanese Patent Application No. 2000-180207, filed Jun. 15, 2000, the entire contents of which are incorporated herein by reference.

### BACKGROUND OF THE INVENTION

This invention relates to a contact pin attached to a contactor used to inspect the electrical characteristics of a to-be-inspected object such as a semiconductor wafer. More particularly, the invention relates to contact pins used to inspect the electrical characteristics of a plurality of integrated circuits formed on a semiconductor wafer.

As one of the inspections for semiconductor devices, there is an inspection for inspecting the electrical characteristics of a plurality of IC chips formed on one surface of a semiconductor wafer. In this inspection, a probe unit is used. The probe unit includes a probe card provided with a number of contact pins. Each contact pin is brought into contact with the electrode pad (made of, for example, a conductive metal such as aluminum or copper, etc.) of a corresponding IC chip. In this contact state, each contact pin relays a signal between a corresponding IC chip and a tester.

To date, a probe card having cantilever-type contact pins has been widely used. Further, recently, the performance of the semiconductor manufacturing apparatuses has remarkably been enhanced, and therefore to-be-inspected objects manufactured by them have likewise become more highly integrated. This means that the number of electrode pads incorporated in each object has significantly increased and accordingly, the pitch of arrangement of the electrode pads has been narrowed. To inspect such highly-integrated objects, it is necessary to increase the number of contact pins included in each probe card. The conventional probe card with cantilever-type contact pins, however, does not have a structure capable of sufficiently following a future increase in the number of contact pins and a future narrower pitch. In light of this, a contactor formed of an insulated substrate with a large number of contact pins has been developed. This contactor allows for such an increase in the number of contact pins and a narrower pitch.

A conventional contact pin P, for example, has a shank 1 and a needle end section 2 as shown in FIG. 6. The needle end section 2 has a structure tapered from the shank 1. A flat surface 3 is formed at the distal end of the needle end section 2. When inspecting a to-be-inspected object (not shown), an inspection pad incorporated in the object is aligned with each contact pin P of the contactor. During the alignment process, light L is emitted to the contact pin P from below as indicated by the arrows in FIG. 6. The position of each contactor pin P is recognized by detecting, using a camera, light R reflected from the flat surface 3 of the needle end section 2. On the basis of the detected position of each contact pin P, the semiconductor wafer and the contactor are aligned with each other.

In accordance with increases in the degree of integration in semiconductor wafers, the electrode pads are increasingly reduced in size and increased in number. Accordingly, the number of contact pins P is increased (to, for example, 3000), and the diameter of the shank 1 of each contact pin P is reduced to, for example, less than 50 μm. Moreover, the wiring layer of each contact pin P is thinned, which requires a reduction in needle pressure. Further, in accordance with the reduction in the area of the flat surface 3 of the needle end section 2 of each contact pin P, it becomes more and more difficult to detect light R reflected from the flat surface 3 by image pickup means such as a camera. As a result, it is very possible that the contact pins P cannot be aligned with the electrode pads on a semiconductor wafer.

### BRIEF SUMMARY OF THE INVENTION

The present invention has been developed to solve the above-described problem, and it is an object of the invention to provide a contact pin which can be reliably detected by image pickup means, even if its diameter and needle pressure are much reduced.

To satisfy the object, according to an aspect of the invention, there is provided a contact pin for use in a contactor for inspecting electrical characteristics of a to-be-inspected object, comprising:

a shank having a lower end surface directed to the to-be-inspected object; and

a needle end section provided on a portion of the lower end surface,

wherein at least part of that portion of the lower end surface, on which the needle end section is not provided, serves as a reflection surface for enabling optical detection of the contact pin.

In this contact pin, it is preferable that the shank is cylindrical.

In this contact pin, it is preferable that a tapered section is provided around the lower end surface.

In this contact pin, it is preferable that the needle end section is provided on a central portion of the lower end surface, and the reflection surface is in a shape that surrounds the needle end section.

In this contact pin, it is preferable that the needle end section has a conical structure.

In this contact pin, it is preferable that the needle end section includes a cylindrical section provided on the lower end surface, and a conical structure provided on a lower end of the cylindrical section.

In this contact pin, it is preferable that the conical structure has a shape of a truncated cone.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A-1D are views illustrating contact pins according to an embodiment of the present invention, FIG. 1A is a sectional view illustrating a state in which contact pins incorporated in a contactor are in contact with electrode pads on a semiconductor wafer, FIG. 1B is a plan view illustrating, from below, a needle pin section included in each contact pin shown in FIG. 1A, FIG. 1C is a view illustrating an example of a reflection surface included in each contact pin, and FIG. 1D is a view illustrating an example of a needle end section included in each contact pin;

FIG. 2 is a view useful in explaining the state of light, which is reflected from each contact pin, shown in FIGS. 1A-1D, for detecting the position of each contact pin;

FIG. 3 is a view useful in explaining the state of light, which is reflected from a conventional contact pin, as shown in FIG. 6, for detecting the position of each contact pin;

FIGS. 4A-4C are views illustrating the structure of a contact pin according to another embodiment of the present invention, FIG. 4A is a side view illustrating the structure, FIG. 4B is a plan view illustrating the structure from below a needle end section incorporated therein, and FIG. 4C is an enlarged view illustrating a main portion of the structure;

FIGS. 5A and 5B are views illustrating the structures of contact pins according to other embodiments of the present invention, FIG. 5A is a structure in which no tapered section is provided at a shank, and FIG. 5B is a structure in which a cylindrical section is provided between a tapered section and a needle end section; and

FIG. 6 is a view of an essential part of a conventional contact pin, useful in explaining the relationship between illumination light and reflected light used for detecting the contact pin.

### DETAILED DESCRIPTION OF THE INVENTION

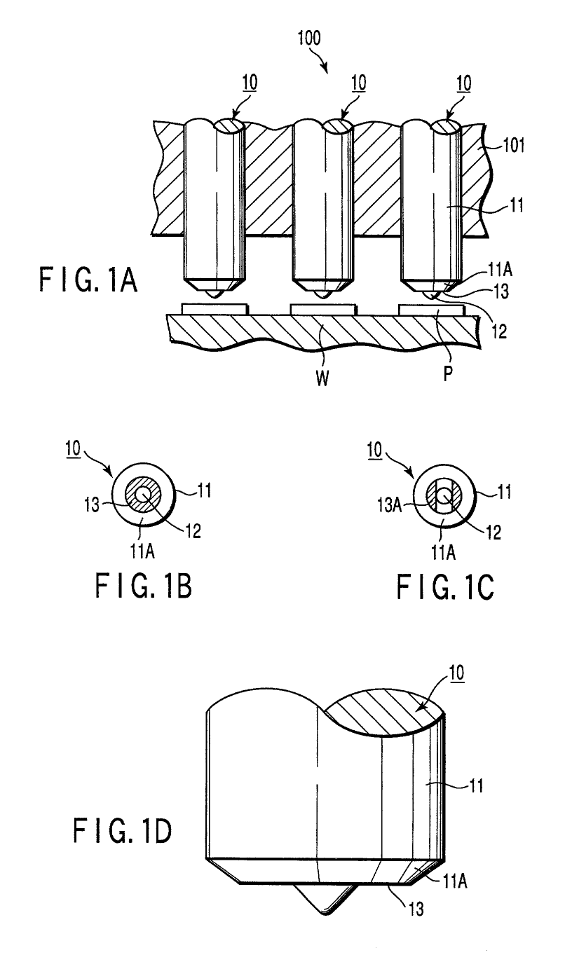

Referring to FIGS. 1A-3, an embodiment of the present invention will be described. As shown in FIG. 1A, a contact pin 10 according to the embodiment is attached to, for example, an insulated substrate 101 incorporated in a contactor 100 for inspecting the electrical characteristics of a to-be-inspected object (e.g. a semiconductor wafer W). The contact pin 10 is a vertical needle to be attached on the insulated substrate 101 aligned with an electrode pad P. As shown in FIG. 1A, the contact pin 10 can be formed of a shank 11 and a needle end section 12. A tapered section 11A can be formed around a lower end surface 13 incorporated in the shank 11 and directed to a to-be-inspected object. The needle end section 12 is provided on a central portion of the lower end surface 13 of the shank 11. The needle end section 12 can have a conical structure (for example, can be formed in a cone). As shown in FIG. 1B, the needle end section 12 is surrounded by a ring-shaped flat surface 13. The flat surface 13 serves as a ring-shaped reflection surface 13 for optically detecting the contact pin 10 using image pickup means such as a camera when aligning the contact pin 10 with the electrode pad P. The reflection surface 13 is not necessarily ring-shaped, but may be formed of parts 13A of the flat surface 13, as is shown in FIG. 1C. The tip of the needle end section 12 sticks in an electrode pad P on the semi-conductor wafer W as a result of a needle pressure applied thereto at the time of inspection, thereby electrically connecting the periphery of the needle end section 12 (i.e. the contact pin 10) to the electrode pad P.

The shank 11 may be formed to have an outer diameter of 50 μm, the ring-shaped reflection surface 13 may have an outer diameter of 20-30 μm and an inner diameter of 10-15 μm, and the needle end section 12 may have a height of approx. 4-10 μm. Further, as shown in FIG. 1D, the needle end section 12 may have the shape of a truncated cone. This shape prevents the needle end section 12 from excessively sticking in the electrode pad. FIG. 6 shows a conventional contact pin P, which has a reflection surface with a diameter of 5 μm at maximum. Since the reflection surface 13 of the contact pin 10 according to the present invention has an area larger than the flat surface of the conventional contact pin, the former can be detected easier than the latter by image pickup means. This means that the contact pin 10 can be aligned with the electrode pad P on the semiconductor wafer more reliably in the present invention than in the conventional case.

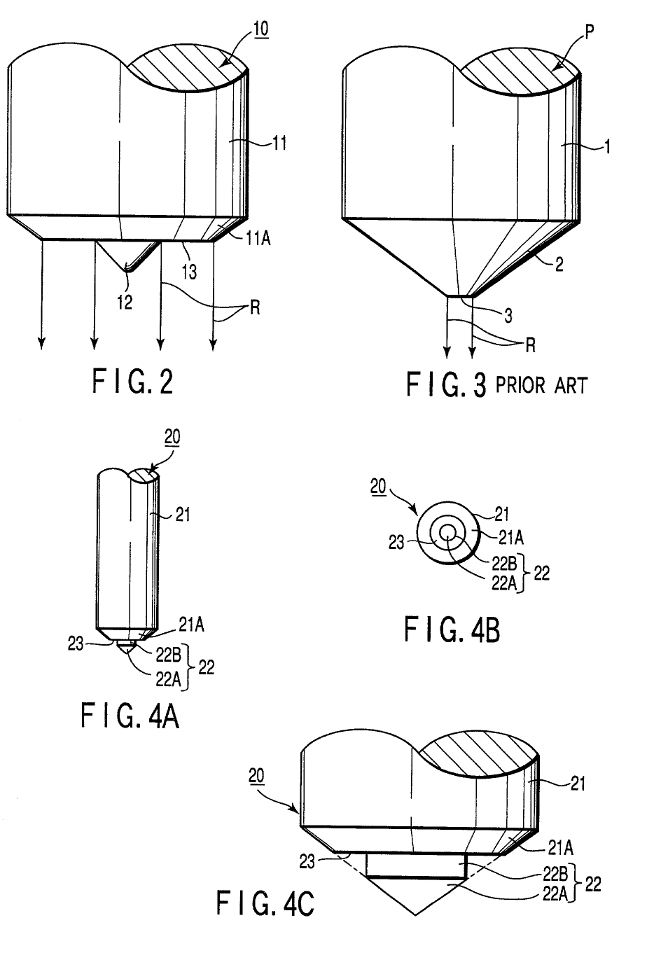

The operation of the contact pin 10 will be described. First, light is emitted, for example, from below the contactor 100 shown in FIG. 1A. Then, as shown in FIG. 2, light R reflected from the reflection surface 13 located around the needle end section 12 of the contact pin 10 is obtained. This reflected light R reaches image pickup means (not shown). The outer diameter of the reflection surface 13 is close to the diameter of the shank 11, and the inner diameter is equal to the outer diameter of the proximal end of the needle end section 12. Accordingly, the area from which light is reflected is large, and therefore, the contact pin 10 can be reliably detected by the image pickup means. On the other hand, it is difficult to make large the flat surface 3 of the conventional contact pin P, which serves as a reflection surface, since the flat surface 3 constitutes the tip of the needle end section 2 as shown in FIG. 6. Therefore, it is also difficult to detect the flat surface 3.

After recognizing the contact pin 10 and aligning it with the electrode pad P, the electrical characteristics of the semiconductor wafer W are inspected, with the wafer W electrically connected to the contact pin 10. The needle end section 12 of the contact pin 10 can be formed in a cone. This means that the needle end section 12 of the contact pin 10 can easily stick in the electrode pad P. In this state, the side surface of the cone is in contact with the electrode pad P and hence electrically connected thereto in a reliable manner, thereby enabling the electrode pad P to be reliably subjected to predetermined inspection.

As described above, in the embodiment, the reflection surface 13 for allowing the contact pin 10 to be detected is provided on a surface around the needle end section 12. When aligning the contact pin 10 with an electrode pad P on a semiconductor wafer W, light emitted to detect the contact pin 10 reflects from the reflection surface 13 and enters the image pickup means such as a camera. The image pickup means can reliably receive light R reflected from the reflection surface 13. In other words, the pickup means can reliably detect the contact pin 10. Further, since the needle end section 12 is formed in a cone, it can reliably stick in the electrode pad P even with a low needle pressure, thereby electrically connecting the contact pin 10 to the electrode pad P in a reliable manner. Therefore, even if the contact pin 10 is further reduced in diameter and needle pressure in the future, in accordance with the development of high integration techniques concerning semiconductor wafers W, the reflection surface 13 provided around the needle end section 12 of the contact pin 10 can be reliably detected and recognized by means such as a camera. As a result, when inspecting a semiconductor wafer W, the contact pin 10 can be reliably aligned with an electrode pad P on the semiconductor wafer W to thereby enable reliable inspection of the electrical characteristics of the semiconductor wafer W.

FIGS. 4A, 4B and 4C show a contact pin according to another embodiment of the invention. As shown in these figures, a contact pin 20 includes a shank 21 and a needle end section 22, and differs in the structure of the needle end section 22 from the contact pin 10 shown in FIGS. 1A-1D. Specifically, as shown in FIGS. 4A and 4B, the needle end section 22 comprises a conical section 22A and a cylindrical section 22B. A reflection surface 23 is provided on a surface around the cylindrical section 22B. The needle end section 22 and the reflection surface 23 can be simultaneously formed by a process for integrally forming, into a cone, the needle end section 22 and a tapered section 21A included in the shank 21, and a process for horizontally cutting a middle portion of the cone as indicated by the dotted line in FIG. 4C. These processes can be carried out, using the NCR grinding technique. This embodiment has the same advantage as the first embodiment.

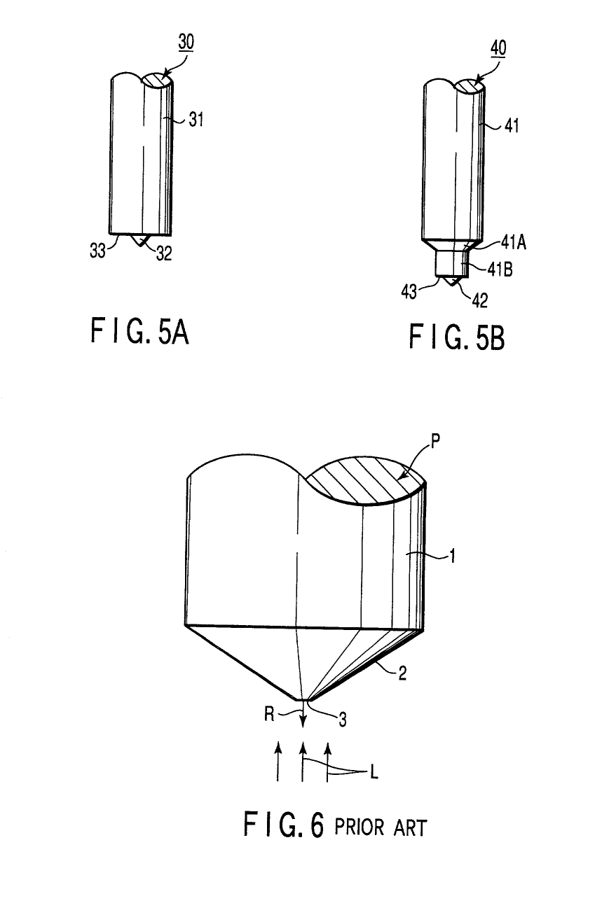

FIGS. 5A and 5B show contact pins according to other embodiments of the invention. As shown in FIG. 5A, a contact pin 30 comprises a shank 31 and a needle end section 32. However, no tapered section is provided at a lower end section of the shank 31, which distinguishes it from the contact pin 10 shown in FIGS. 1A-1D. Further, a reflection surface 33 has the same outer diameter as the shank 31. Thus, the reflection surface 33 can be formed larger than those shown in FIGS. 1A-1D and 4A-4C. A contact pin 40 shown in FIG. 5B comprises a shank 41 and a needle end section 42. A lower end portion of the shank 41 includes a tapered section 41A, and a cylindrical section 41B linearly extending from the lower end of the tapered section 41A. The needle end section 42, which is in the form of a cone, extends from the lower end of the cylindrical section 41B. A reflection surface 43 is formed of a ring-shaped surface that is included in the lower end surface of the cylindrical section 41B and surrounds the needle end section 42. The embodiments shown in FIGS. 5A and 5B provide the same advantage as the above-described embodiments.

The present invention is not limited to the above-described embodiments, but may be modified in various ways. The present invention relates to a contact pin, having a shank and a needle end section, for use in a contactor for inspecting the electrical characteristics of a to-be-inspected object, and covers any structure in which a reflection surface for enabling the detection of the contact pin is provided around the needle end section.

The present invention can provide a contact pin which can be reliably detected by image pickup means even when its diameter and needle pressure are much reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A contact pin for use in a contactor for inspecting electrical characteristics of a to-be-inspected object, comprising:
a shank having a lower end surface directed to the to-be-inspected object; and
a needle end section provided on a portion of the lower end surface,
wherein at least part of that portion of the lower end surface, on which the needle end section is not provided, serves as a reflection surface for enabling optical detection of the contact pin.

2. The contact pin according to claim 1, wherein the shank is cylindrical.

3. The contact pin according to claim 1, wherein a tapered section is provided around the lower end surface.

4. The contact pin according to claim 1, wherein the needle end section is provided on a central portion of the lower end surface, and the reflection surface is in a shape that surrounds the needle end section.

5. The contact pin according to claim 1, wherein the needle end section has a conical structure.

6. The contact pin according to claim 1, wherein the needle end section includes a cylindrical section provided on the lower end surface, and a conical structure provided on a lower end of the cylindrical section.

7. The contact pin according to claim 5 or 6, wherein the conical structure has a shape of a truncated cone.
